(19) United States
(12) Patent Application Publication
(10) Pub. No.: US 2013/0128913 A1
(43) Pub. Date: May 23, 2013

(54) ELECTRICALLY POWERED INDUSTRIAL FURNACES HAVING MULTIPLE INDIVIDUALLY CONTROLLABLE POWER SUPPLIES AND SHORTENED CABLING REQUIREMENTS

(71) Applicant: Warner Power, LLC, Warner, NH (US)

(72) Inventor: Peter Graham Amos, Warner, NH (US)

(73) Assignee: Warner Power, LLC., Warner, NH (US)

(21) Appl. No.: 13/668,967

(22) Filed: Nov. 5, 2012

Related U.S. Application Data
(60) Provisional application No. 61/555,664, filed on Nov. 4, 2011.

(51) Int. Cl. H05B 3/62

(52) U.S. Cl. CPC H05B 3/62
USPC 373/109

(57) ABSTRACT

An electrically powered industrial furnace uses a number of distributed, highly compact power supplies physically located generally immediately adjacent to each of the furnace electrical terminals, so that cabling and bus-bars can essentially be eliminated. In addition, each heating element has its own dedicated and independently controllable power supply which can automatically adjust for varying resistances in the single connected heating element and/or short cabling, to achieve a precisely uniform temperature within the furnace.

### CROSS-REFERENCE TO RELATED APPLICATIONS

This application claims priority from U.S. Provisional Application Ser. No. 61/555,664 titled “POWER AT THE LOAD' FOR ELECTRICALLY POWERED INDUSTRIAL FURNACES, INCLUDING VACUUM FURNACES AND CRYSTAL GROWING FURNACES”, which was filed on Nov. 04, 2011, which is incorporated fully herein by reference.

### TECHNICAL FIELD

The present invention relates to electrically powered industrial furnaces and more particularly, relates to an electrically powered industrial furnace that uses a plurality of distributed, highly compact power supplies physically located generally immediately adjacent to each of the furnace electrical terminals, so that cabling and bus-bars can essentially be eliminated. In addition, each heating element may have its own dedicated and independently controllable power supply which can automatically adjust for varying resistances in the single connected heating element, to achieve a precisely uniform temperature within the furnace.

### BACKGROUND INFORMATION

Electrically powered industrial furnaces typically have a plurality of heating elements, regularly spaced within the furnace. This is to ensure a uniform temperature throughout the hot zone.

Such furnaces typically utilize low voltages below 50V (AC or DC) for operator safety and avoidance of internal arcing. Consequently they require heavy currents to deliver the required power, which may range from 20 kW to 1MW or more.

Conventionally, electrical power is supplied by a stand-alone electrical power supply, or power supplies, in a dedicated enclosure(s) separate and apart from that of the furnace itself, which may include a transformer and power regulating circuits. The output, or outputs, from the power supply may be DC, AC single-phase, or AC three-phase. Typically, for high power applications, either water-cooled cables, or bus-bars, are used to connect from the power supply terminals to the electrical terminals at the furnace. Such cables or bus-bars create resistive losses which reduce efficiency. Additionally in AC systems, inductive coupling to nearby ferromagnetic steel components can cause parasitic heating in those nearby ferromagnetic steel components and corresponding energy losses. Such resistances and inductive losses can cause an imbalance in the system, which can cause an imbalance at the heating elements and undesirable temperature gradients within the furnace which may degrade the industrial process, reducing the quality, yield and/or market value of the ultimate finished product being processed in the furnace. Further thermal imbalance may be created by differences in the resistance values of the individual heating elements themselves, due to aging, which cannot be compensated for, where several such elements are powered from a single power supply.

Because of the very high currents, typically 1,000-20,000 A, resistive losses in the cables or bus bars can be very significant and degrade the overall efficiency of the system. Such losses may exceed 10% of total power consumed and may additionally require water-cooling to prevent over-heating. Furthermore water-cooled cables and bus-bars are heavy, expensive and cumbersome and the power losses can be a very significant addition to the overall operating cost.

By means of example, FIG. 1 (Prior art) shows a 3 phase Power Supply 10 and furnace 12 with conventional inter-connecting cables or bus-bars 14. Heating elements are shown at 16, connected in a Delta formation.

Accordingly, what is needed is a system and method of providing multiple power supplies for an electrically powered industrial furnace wherein a number of distributed, highly compact power supplies are physically located generally immediately adjacent to each of the furnace electrical terminals, so that cabling and bus-bars can essentially be eliminated. In addition, each heating element should be able to have its own dedicated and independently controllable power supply which can automatically adjust for varying resistances in the single connected heating element (and/or any cabling), to achieve a precisely uniform temperature within the furnace.

### SUMMARY

The present invention features a furnace, wherein the furnace comprises a plurality of single heating elements; a plurality of furnace electrical terminals, wherein each of the plurality of single heating elements contains at least one of the plurality of furnace electrical terminals; a plurality of power supplies, wherein each of the plurality of power supplies are located adjacent to each of the furnace electrical terminals; and a plurality of short cables, wherein each of the plurality of single heating elements is configured to connect to a single one of the plurality of power supplies via one or more of the plurality of short cables. The plurality of power supplies may be highly compact power supplies. Each of the plurality of heating elements may have its own dedicated and independently controllable power supply and each of the plurality of power supplies may be configured to automatically adjust for varying resistances in the single connected heating element. Each of the plurality of short cables may be between one and six feet in length.

In another embodiment of the present invention, a furnace comprises three heating elements and three distributed power supplies, wherein each of the three distributed power supplies is configured to supply power to a single phase heating element within the furnace, with each of the three heating elements having an individual power supply. In the furnace, a first power supply is connected to a first heating element, a second power supply is connected to a second heating element and a third power supply is connected to a third heating element, and the connections are formed using inter-connecting cables or bus-bars that are less than six feet in length.

In an alternate embodiment, a furnace comprises a plurality of single heating elements; a plurality of power supplies, wherein each of the plurality of power supplies are located adjacent to each of the single heating elements; and a plurality of short cables, wherein each of the plurality of single heating elements is configured to connect to a single one of the plurality of power supplies via one or more of the plurality of short cables.

In this embodiment, the furnace may be a bell furnace with a top that lifts off and the plurality of power supplies may be mounted onto the top of the bell furnace, wherein the plurality of short cables are high voltage supply cables.

### BRIEF DESCRIPTION OF THE DRAWINGS

These and other features and advantages of the present invention will be better understood by reading the following detailed description, taken together with the drawings wherein:

FIG. 1 is a detailed view of a prior art 3 phase power supply and furnace with conventional inter-connecting cables or bus-bars; and

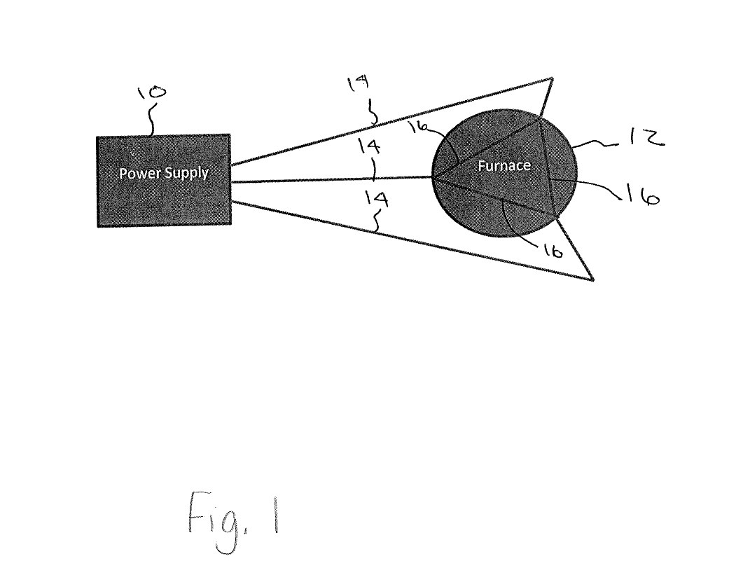

FIG. 2 is a detailed view of a plurality of distributed power supplies each serving a single phase heating element according to one embodiment of the present invention.

### DETAILED DESCRIPTION OF THE PREFERRED EMBODIMENTS

To address these various problems set forth above, which are generic in the industry, the present invention uses a plurality of distributed, highly compact power supplies 20 physically located generally immediately adjacent to each of the furnace electrical terminals 28, so that cabling and bus-bars 24 can essentially be eliminated. In addition, each heating element 22 has its own dedicated and independently controllable power supply 20 which can automatically adjust for varying resistances in the single connected heating element 22 (and/or bus bars and cabling 24), to achieve a precisely uniform temperature within the furnace 26.

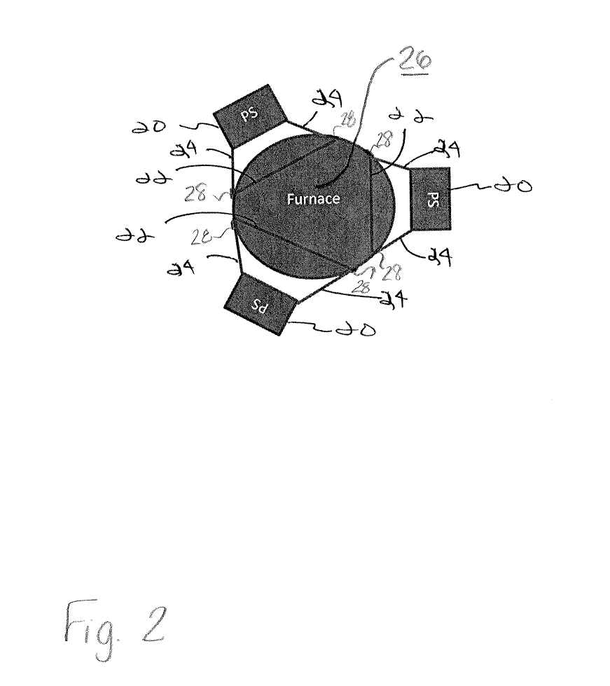

As shown in the exemplary preferred embodiment shown in FIG. 2, three (3) distributed power supplies (PS) 20, each serve a single phase heating element 22 within the furnace 26, with each heating element 22 having an individual power supply 20 and individual regulation. The inter-connecting cables or bus-bars 24 are very short as shown and thus do not suffer from the same problems (resistive losses) as in the prior art. For example, the cables 24 may be 1 to 6 feet in length as opposed to prior art systems that utilize cables 14 that are much longer and typically in the range of 16 to 24 feet in length.

For example, when this system is used with a bell furnace or another type of furnace where the top (the bell) lifts off for access to the cheating chamber, it is common to have very long, looped cables that supply power to the heaters inside the bell. The cables are long and looped to allow the vertical motion. These cables are often heavy, high current cables with resistive and parasitic losses. By mounting the power supply modules right on the bell, the use of the heavy, high current cables can be eliminated. By mounting the power supply modules on the bell, high voltage supply cables can be used which are much lighter weight and lower current.

Modifications and substitutions by one of ordinary skill in the art are considered to be within the scope of the present invention, which is not to be limited except by the allowed claims and their legal equivalents.

The invention claimed is:

1. A furnace, wherein said furnace comprises:
a plurality of single heating elements;
a plurality of furnace electrical terminals, wherein each of said plurality of single heating elements contains at least one of said plurality of furnace electrical terminals;
a plurality of power supplies, wherein each of said plurality of power supplies are located adjacent to each of said furnace electrical terminals; and
a plurality of short cables, wherein each of said plurality of single heating elements is configured to connect to a single one of said plurality of power supplies via one or more of said plurality of short cables.

2. The furnace of claim 1, wherein said plurality of power supplies are highly compact.

3. The furnace of claim 1, wherein each of said plurality of heating elements has its own dedicated and independently controllable power supply and wherein each of said plurality of power supplies is configured to automatically adjust for varying resistances in the single connected heating element.

4. The furnace of claim 1, wherein each of said plurality of short cables are between one and six feet in length.

5. A furnace, wherein said furnace comprises:
three heating elements and three distributed power supplies, wherein each of said three distributed power supplies is configured to supply power to a single phase heating element within the furnace, with each of said three heating elements having an individual power supply.

6. The furnace of claim 5, wherein a first power supply is connected to a first heating element, a second power supply is connected to a second heating element and a third power supply is connected to a third heating element, wherein said connections are formed using inter-connecting cables or bus-bars that are less than six feet in length.

7. A furnace, wherein said furnace comprises:
a plurality of single heating elements;
a plurality of power supplies, wherein each of said plurality of power supplies are located adjacent to each of said single heating elements; and
a plurality of short cables, wherein each of said plurality of single heating elements is configured to connect to a single one of said plurality of power supplies via one or more of said plurality of short cables.

8. The furnace of claim 7, wherein said furnace is a bell furnace with a top that lifts off and wherein said plurality of power supplies are mounted onto said top of said bell furnace, wherein said plurality of short cables are high voltage supply cables.
